(19) United States
(12) Patent Application Publication
(10) Pub. No.: US 2009/0290930 A1
(43) Pub. Date: Nov. 26, 2009

(54) SHEET PROTECTOR

(75) Inventors: Joseph L. Rodriguez, JR., Jensen Beach, FL (US); Stephen P. Corr, Gurnee, IL (US); Jennifer J. Dortch, Pleasant Prairie, WI (US)

Correspondence Address: MICHAEL BEST & FRIEDRICH LLP, 100 EAST WISCONSIN AVENUE, SUITE 3300, MILWAUKEE, WI, 53202, US

(73) Assignee: ACCO BRANDS USA LLC, Lincolnshire, IL (US)

(21) Appl. No.: 12/125,114

(22) Filed: May 22, 2008

(51) Int. Cl. B42F 13/16

(52) U.S. Cl. 402/79

(57) ABSTRACT

A sheet protector for use with a binder including a ring. The sheet protector includes a first cover having a hole configured to receive the ring, a second cover coupled to the first cover along a first edge and a second edge and uncoupled to the first cover along at least a portion of a third edge and at least a portion of a fourth edge, and a tab coupled to the second cover proximate to the third edge. The tab is configured to engage the ring.

### BACKGROUND

The present invention relates to a sheet protector.

Sheet protectors are commonly used as a protective covering for paper documents, or sheets. Typically, a sheet protector includes a front cover and a rear cover coupled to the front cover along three edges. The front and rear covers are commonly uncoupled along a top edge to allow a user to insert and remove a sheet from the sheet protector.

### SUMMARY

In some sheet protector constructions, the front cover and the rear cover are only coupled along two edges such that the front cover may be opened relative to the rear cover, facilitating insertion and removal of the sheet. However, in such constructions, the covers may be difficult to separate or may become separated unintentionally, exposing the sheet positioned within the sheet protector.

In one embodiment, the invention provides a sheet protector for use with a binder including a ring. The sheet protector includes a first cover having a hole configured to receive the ring, a second cover coupled to the first cover along a first edge and a second edge and uncoupled to the first cover along at least a portion of a third edge and at least a portion of a fourth edge, and a tab coupled to the second cover proximate the third edge. The tab is configured to engage the ring.

In another embodiment, the invention provides a sheet protector for use with a binder including a ring. The sheet protector includes a first cover having a hole configured to receive the ring and a second cover coupled to the first cover. The second cover is movable relative to the first cover between a first position, whereby the first cover and the second cover are configured to receive a sheet, and a second position, whereby the sheet is substantially enclosed within the first cover and the second cover. The sheet protector also includes a tab coupled to the second cover to facilitate movement between the first position and the second position. The tab is configured to engage the ring when in the second position.

In yet another embodiment, the invention provides a method of enclosing a sheet within a sheet protector for use with a binder including a ring. The sheet protector includes a first cover having a hole configured to receive the ring, a second cover coupled to the first cover along a first edge and a second edge and uncoupled to the first cover along at least a portion of a third edge and at least a portion of a fourth edge, and a tab coupled to the second cover proximate to the third edge. The method includes opening the second cover along at least a portion of the third edge and at least a portion of the fourth edge relative to the first cover, inserting the sheet between the first cover and the second cover, closing the second cover relative to the first cover, and engaging the ring with the tab.

Other aspects of the invention will become apparent by consideration of the detailed description and accompanying drawings.

### BRIEF DESCRIPTION OF THE DRAWINGS

FIG. 1 is a planar view of a sheet protector embodying the present invention.

FIG. 2 is a planar view of the sheet protector shown in FIG. 1 receiving a sheet, the sheet protector in an open position.

FIG. 3 is a perspective view of the sheet protector shown in FIG. 1 coupled to a binder, the sheet protector in a closed position.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Although references are made below to directions, such as “top”, “bottom”, “left”, “right”, “front”, “rear”, or the like, the references are made relative to the drawings (as normally viewed) for convenience. These directions are not intended to be taken literally or to limit the present invention any form.

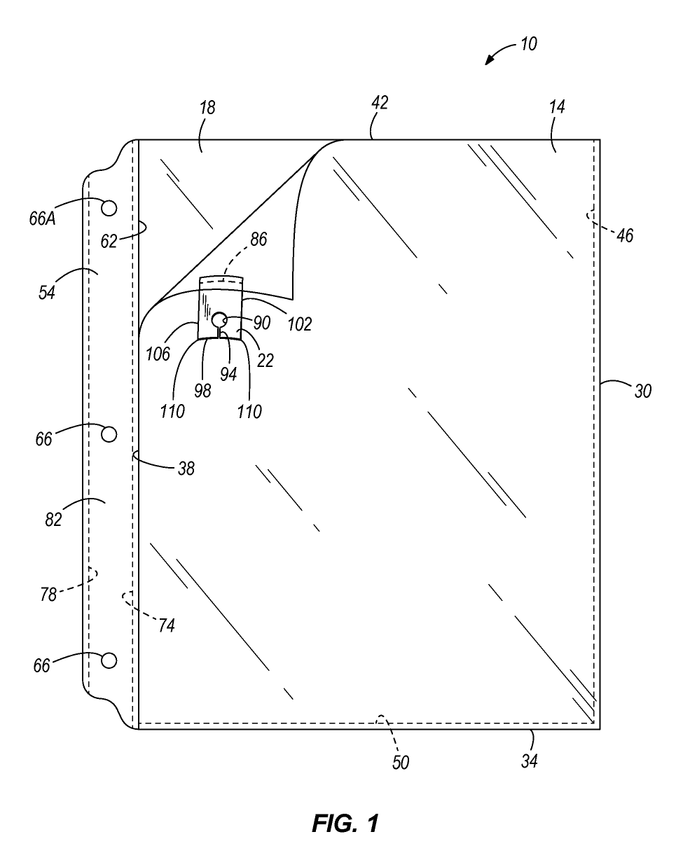

FIG. 1 illustrates a sheet protector 10 embodying the present invention. In the illustrated embodiment, the sheet protector 10 is configured to receive and enclose one or more standard sheets of paper (e.g., 8.5×11 paper, A4 paper, etc.). In other embodiments, the sheet protector 10 may receive and enclose non-standard sized paper and/or other types of sheets such as, for example, construction paper, cardstock, photographs, or the like.

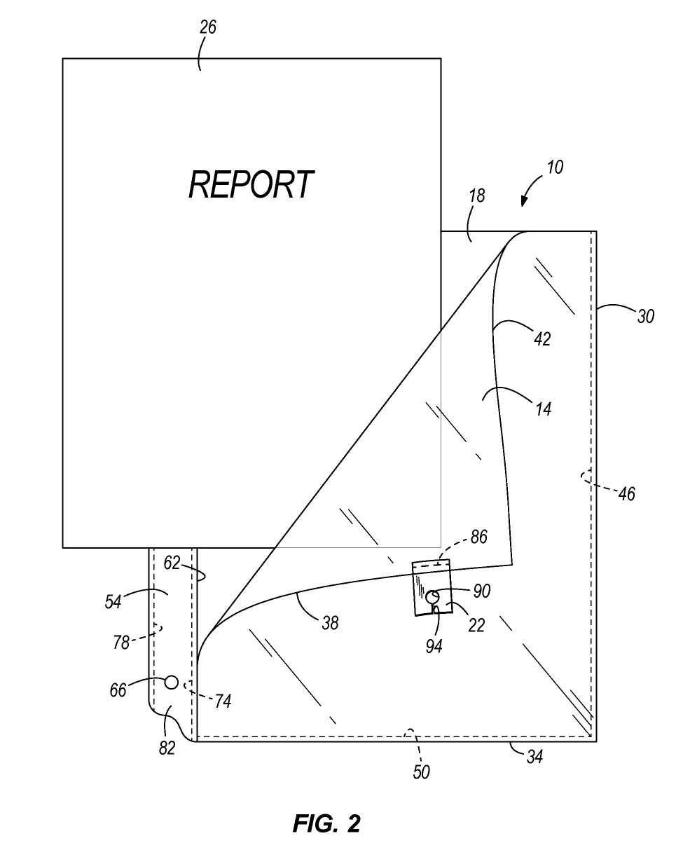

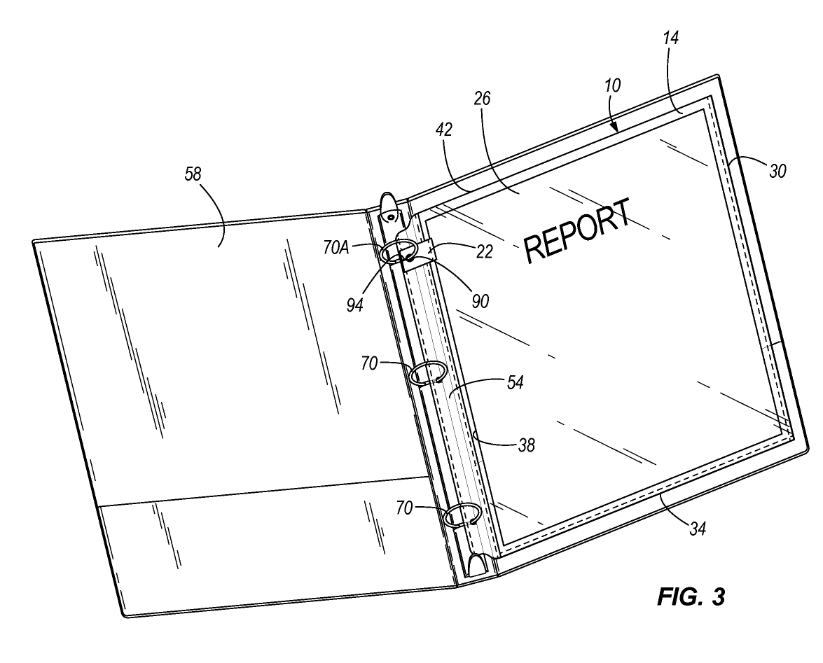

As shown in FIG. 1, the sheet protector 10 includes a front cover 14, a rear cover 18, and a tab 22. In the illustrated embodiment, the front cover 14 and the rear cover 18 are composed of a transparent material such that a sheet 26 (FIGS. 2 and 3) enclosed between the covers 14, 18 is visible and readable. In other embodiments, the covers 14, 18 may be composed of a non-transparent or semi-transparent material. Additionally or alternatively, the front and rear covers 14, 18 may be composed of different materials. For example, the rear cover 18 may be composed of a stiffer, non-transparent material to provide support, while the front cover 14 may be composed of a bendable, transparent material such that the front cover 14 may be easily separated from the rear cover 18.

The illustrated front cover 14 includes a right edge 30, a bottom edge 34, a left edge 38, and a top edge 42. In the illustrated embodiment, the front cover 14 is coupled to the rear cover 18 by a first weld line 46 proximate and parallel to the right edge 30 and a second weld line 50 proximate and parallel to the bottom edge 34. In the illustrated embodiment, the weld lines 46, 50 are formed by, for example, ultrasonic or heat welding. In other embodiments, the front cover 14 may be coupled to the rear cover 18 by an adhesive, stitches, staples, or other conventional technique. In still other embodiments, the front cover 14 and the rear cover 18 may be formed from a single sheet that is folded over itself (e.g., approximately in half). In such embodiments, the right edge 30 may be a fold line and the first weld line 46 may be omitted such that the fold line defines the front cover 14 from the rear cover 18.

The illustrated left edge 38 and the top edge 42 are uncoupled to the rear cover 18 such that the front cover 14 may be partially separated from the rear cover 18 (i.e., opened). In other embodiments, the front cover 14 may be uncoupled to the rear cover 18 along only a portion of each edge 38, 42. As further discussed below, separating the front and rear covers 14, 18 facilitates insertion and removal of the sheet 26 into and from the sheet protector 10.

The illustrated rear cover 18 includes a binding section 54 that is configured to engage a three-ring binder 58 (FIG. 3). In the illustrated embodiment, the binding section 54 is positioned adjacent to a left portion 62 of the rear cover 18 and includes three holes 66 corresponding to rings 70 of the illustrated binder 58. The left portion 62 defines an interface or junction between a main body of the rear cover 18 and the binding section 54. In other embodiments, the sheet protector 10 may be configured for use with other binders or binder elements (e.g., a two-ring binder, a four ring binder, a binding comb, a spiral binding spine, or the like). In such embodiments, the binding section 54 may include fewer or more holes 66 or holes positioned at substantially different locations. Additionally or alternatively, the binding section 54 may be positioned adjacent to a different edge of the rear cover 18 depending on the desired orientation of the sheet protector 10.

In the illustrated embodiment, the binding section 54 is composed of a portion of the front cover 14 and a portion of the rear cover 18. As shown in FIG. 1, the binding section 54 includes a third weld line 74 and a fourth weld line 78, which may be formed in a similar manner to the first and second weld lines 46, 50 or may be formed by a different technique. The illustrated weld lines 74, 78 couple the portion of the front cover 14 to the corresponding portion of the rear cover 18. The front cover 14 is then cut along the left edge 38, separating the front cover 14 from the binding section 54 and uncoupling the left edge 38 of the front cover 14 from the rear cover 18. In some embodiments, such as the illustrated embodiment, a relatively stiff insert 82 is positioned in the binding section 54 between the third and fourth weld lines 74, 78 to provide additional strength at the binding section 54. In such embodiments, the insert 82 may include writings or markings to designate a product name, manufacturer, product specification, or the like.

As shown in FIG. 1, the tab 22 is coupled to the front cover 14 by ultrasonic or heat welding along a weld line 86. In other embodiments, the tab 22 may be coupled to the front cover 14 by an adhesive, stitches, staples, or the like. The illustrated tab 22 includes a hole 90 and a slit 94 extending between the hole 90 and an edge of the tab 22. In the illustrated embodiment, the slit 94 is a substantially linear slit that extends to a left edge 98 of the tab 22 (i.e., the edge opposite the weld line 86). In other embodiments, the slit 94 may extend to a top edge 102, a bottom edge 106, or a corner 110 of the tab. Additionally or alternatively, the slit 94 may be non-linear. While the illustrated slit 94 has a width such that a portion of the tab 22 has been removed to form the slit 94, in other embodiments the slit 94 may be created by a single cut such that substantially no material is removed from the tab 22 to form the slit 94. In the illustrated embodiment, the tab 22 is composed of polypropylene, although other suitable materials may be used to form the tab 22.

The illustrated tab 22 is coupled to the front cover 14 proximate to the left edge 38 and the top edge 42 of the cover 14 and positioned to engage and receive the top ring 70A of the binder 58. As shown in FIG. 3, when the front cover 14 is substantially aligned with the rear cover 18 (i.e., when the front cover 14 is closed), the hole 90 of tab 22 substantially aligns with the top hole 66A of the binding section 54. In other embodiments, the tab 22 may be positioned to engage a different ring 70 of the binder 58 and align with a different hole 66 of the binding section 54, or the tab 22 may be positioned and configured to engage a different portion of a different binder element (e.g., a tooth of a binding comb, a loop of a binding spiral, or the like). However, positioning the tab 22 proximate to the top edge 42 of the front cover 14 provides a greater amount of leverage to separate (e.g., lift) the front cover 14 from the rear cover 18 than if the tab 22 were positioned to engage a different ring 70 of the binder 58.

Referring to FIGS. 2 and 3, the front cover 14 is movable between an open position (FIG. 2), whereby the front cover 14 and the rear cover 18 are configured to receive the sheet 26, and a closed position (FIG. 3), whereby the sheet 26 is substantially enclosed within the front cover 14 and the rear cover 18. When in the closed position, the tab 22, and more particularly the hole 90 of the tab 22, engages the top ring 70A of the three-ring binder 58. The tab 22 releasably secures the front cover 14 in the closed position to inhibit the front cover 14 from unintentionally separating from the rear cover 18.

Although the sheet protector 10 is described as receiving the sheet 26 while in the illustrated open position, it should be readily apparent to one skilled in the art that the front cover 14 may be opened relative to the rear cover 18 by a greater or lesser amount than that illustrated to receive the sheet 26. Additionally, it should be readily apparent that a user may still insert and remove the sheet 26 through the top edge 42 even when the sheet protector 10 is in the closed position. However, opening the front cover 14 greatly facilitates insertion, removal, and proper alignment of the sheet 26 within the sheet protector 10, while reducing the risk of tearing, creasing, or otherwise damaging the sheet 26 during insertion and removal.

In operation, a user opens the front cover 14 relative to the rear cover 18 by lifting the tab 22 and/or a portion of the front cover 14, separating the left edge 38 and the top edge 42 of the front cover 14 from the rear cover 18. The user then inserts the sheet 26 between the covers 14, 18 until the sheet 26 is in a desirable position in the sheet protector 10 (e.g., centered within a periphery of the rear cover 18). Next, the user closes the front cover 14 such that the sheet 26 is substantially enclosed between the front cover 14 and the rear cover 18. If the sheet protector 10 is already coupled to the three-ring binder 58 (as shown in FIG. 3), the user presses the tab 22 over the top ring 70A of the binder 58, momentarily expanding the slit 94 to allow the top ring 70A to pass through the slit 58 and enter the hole 90 of the tab 22. In such an arrangement, the tab 22 engages the ring 70A without requiring the user to open the rings 70. If the sheet protector 10 is not coupled to the three-ring binder 58, the front cover 14 may simply be closed such that the hole 90 of the tab 22 is substantially aligned with the top hole 66A of the binding section 54. In such an arrangement, the sheet protector 10 may be coupled to the binder 58 at a later time, if desired. The hole 90 of the tab 22 receives the ring 70A as it passes through the slit 94 or as the rings 70 are closed, releasably securing the tab 22 to the binder 58 and, thereby, the front cover 14 to the rear cover 18.

To remove the sheet 26, the above operation is performed in reverse. More specifically, the user lifts the tab 22 and/or a portion of the front cover 14 to release the tab 22 from the top ring 70A of the binder 58. As the top ring 70A slides out of the hole 90 of the tab 22, the slit 94 momentarily expands to allow the ring 70A to pass through the slit 94. The front cover 14 is then opened and the sheet 26 previously enclosed between the front cover 14 and the rear cover 18 is removed.

Various features and advantages of the invention are set forth in the following claims.

What is claimed is:

1. A sheet protector for use with a binder including a ring, the sheet protector comprising:
a first cover including a hole configured to receive the ring;
a second cover coupled to the first cover along a first edge and a second edge and uncoupled to the first cover along at least a portion of a third edge and at least a portion of a fourth edge; and
a tab coupled to the second cover proximate to the third edge, the tab configured to engage the ring.

2. The sheet protector of claim 1, wherein the tab includes a hole configured to receive the ring.

3. The sheet protector of claim 2, wherein the tab includes a slit extending between the hole of the tab and an edge of the tab.

4. The sheet protector of claim 2, wherein the hole of the first cover and the hole of the tab are substantially aligned when the second cover is in a closed position relative to the first cover.

5. The sheet protector of claim 1, wherein the tab releasably secures the second cover in a closed position relative to the first cover when the tab engages the ring.

6. The sheet protector of claim 1, wherein at least one of the first cover and the second cover is composed of a substantially transparent material.

7. The sheet protector of claim 1, wherein the second cover is welded to the first cover along at least one of the first edge and the second edge.

8. The sheet protector of claim 1, wherein the tab is welded to the second cover.

9. A sheet protector for use with a binder including a ring, the sheet protector comprising:
a first cover including a hole configured to receive the ring;
a second cover coupled to the first cover, the second cover movable relative to the first cover between a first position, whereby the first cover and the second cover are configured to receive a sheet, and a second position, whereby the sheet is substantially enclosed within the first cover and the second cover; and
a tab coupled to the second cover to facilitate movement between the first position and the second position, the tab configured to engage the ring when in the second position.

10. The sheet protector of claim 9, wherein the tab includes a hole configured to receive the ring.

11. The sheet protector of claim 10, wherein the tab includes a slit extending between the hole of the tab and an edge of the tab.

12. The sheet protector of claim 10, wherein the hole of the first cover and the hole of the tab are substantially aligned when the second cover is in the second position.

13. The sheet protector of claim 9, wherein the tab releasably secures the second cover in the second position when the tab engages the ring.

14. The sheet protector of claim 9, wherein at least one of the first cover and the second cover is composed of a substantially transparent material.

15. The sheet protector of claim 9, wherein the second cover is welded to the first cover along a first edge and a second edge and is uncoupled to the first cover along at least a portion of a third edge and at least a portion of a fourth edge, and wherein the tab is coupled proximate to the third edge of the second cover.

16. The sheet protector of claim 15, wherein the tab is welded proximate to the third edge of the second cover.

17. A method of enclosing a sheet within a sheet protector for use with a binder including a ring, the sheet protector including a first cover having a hole configured to receive the ring, a second cover coupled to the first cover along a first edge and a second edge and uncoupled to the first cover along at least a portion of a third edge and at least a portion of a fourth edge, and a tab coupled to the second cover proximate to the third edge, the method comprising:
opening the second cover along at least a portion of the third edge and at least a portion of the fourth edge relative to the first cover;
inserting the sheet between the first cover and the second cover;
closing the second cover relative to the first cover; and
engaging the ring with the tab.

18. The method of claim 17, wherein the tab includes a hole, and wherein engaging the ring with the tab includes receiving the ring in the hole of the tab.

19. The method of claim 18, wherein the tab includes a slit extending between the hole of the tab and an edge of the tab, and wherein engaging the ring with the tab includes passing the ring through the slit to receive the ring in the hole of the tab.

20. The method of claim 18, wherein closing the second cover relative to the first cover includes substantially aligning the hole of the tab with the hole of the first cover.
